(19) United States
(12) Patent Application Publication
(10) Pub. No.: US 2003/0043908 A1
(43) Pub. Date: Mar. 6, 2003

(54) Bandwidth scalable video transcoder

(76) Inventor: Cheng Wei Gao, Issaquah, WA (US)

Correspondence Address: BACON & THOMAS, PLLC, 625 SLATERS LANE, FOURTH FLOOR, ALEXANDRIA, VA, 22314

(21) Appl. No.: 09/945,658

(22) Filed: Sep. 5, 2001

(51) Int. Cl. H04N 7/12

(52) U.S. Cl. 375/240.12; 375/240.2; 375/240.23; 375/240.03

(57) ABSTRACT

A video transcoding method and apparatus enables digital video to be transmitted over various network infrastructures by transcoding video data to fit available bandwidth. A transcoder extracts MPEG video data from the video stream wrapper and decomposes the MPEG layered data to the block level. The transcoder then processes the variable length coding (VLC) of discrete cosine transform (DCT) coefficients without having to decode and re-code the video stream. Processing involves assigning an allowable error range to each DCT frequency in the video stream based on the available network bandwidth and/or the effect of the DCT code on perception of picture quality, and adapting video traffic dynamically by changing large length codes to small length codes based on the assigned allowable error range. The larger the allowable error ranges that are assigned to the DCT frequencies, the more video traffic may be trimmed off from the incoming video stream. The video transcoding method and apparatus thus permits dynamic adaptation of the video traffic through tuning of the allowable error range for each DCT frequency.

### BACKGROUND OF THE INVENTION

1. Field of the Invention

This invention relates to a video transcoding method and apparatus that enables digital video to be transmitted over various network infrastructures and media, and in particular to a method and apparatus that is capable of transcoding video data to fit available bandwidth.

According to a preferred embodiment of the invention, the transcoder extracts MPEG video data from the video stream wrapper and decomposes the MPEG layered data to the block level. The transcoder then processes the variable length coding (VLC) of discrete cosine transform (DCT) coefficients without having to decode video signals in the frequency domain to the format in the pixel domain and recode the video in the pixel domain to the format in the frequency domain. Processing involves assigning an allowable error range to each DCT frequency in the video stream based on the available network bandwidth and/or the effect of the DCT code on perception of picture quality, and changing large length codes to small length codes based on the assigned allowable error range. The transcoder can dynamically adapt video traffic through tuning of the allowable error range for each DCT frequency.

The transcoding engine provided by the method and apparatus of the invention can in principle be applied to a number of different types of network, including the Internet and wireless communications networks, and since it does not require any dedicated hardware, can easily be applied to any node or router on the networks. In addition, the transcoding engine of the invention may be used to transcode not only MPEG (an acronym for the Motion Picture Experts Group standards organization), but also other similar block based streaming video compression formats.

2. Description of Related Art

The present invention seeks to facilitate streaming video transmissions, i.e., the ability of a video transmission to be transmitted over networks having varying bandwidths such as the Internet and various wireless networks. It is intended to address problems related to the effect of network congestion on the video stream and, in the case of wireless networks, the availability and high cost of mobile bands.

The conventional solution to the problem of supplying video over congested network links has been to randomly drop video signals from the video stream. This method can significantly degrade picture quality at the receiving end due to visually important information loss. In wireless networks, the problem of information loss is compounded by the impossibility of streaming video with one baseband bandwidth using current video coding technologies. Several bands must be combined together to deliver video service. However, mobile bands are an expensive resource and cannot be assigned to one user over the long period of time necessary to deliver a video stream.

One way to avoid randomly dropping video signals when network bandwidth is not wide enough to transmit all of the signals, and therefore to avoid the consequent degradation in video quality, is to fully recover the incoming compressed video stream into the pixel domain, and then recode the uncompressed video signals to accommodate the available network bandwidth.

According to this prior approach, the transcoder first decodes a compressed video stream. After extracting the MPEG signals from the video stream, the transcoder applies an MPEG decoder to the extracted MPEG video and restores the compressed MPEG video to the uncompressed pixel domain. Thereafter, the transcoder employs an MPEG encoder to re-encode the restored video in the pixel domain back to the compressed video.

More specifically, as illustrated in FIG. 1, the conventional video transcoder 100 includes a decoder 110 and an encoder 150. A previously compressed and packed video stream is input to an MPEG video stream extractor (MVSE) 105, which supplies the extracted MPEG video stream to a variable length decoder (VLD) 115. A dequantizer 120 processes the output of the VLD 115 using a first quantization step size Q1. An inverse DCT processor 125 processes the output of the inverse quantizer 120 and supplies pixel domain data to an adder 130, which sums the pixel domain data with either a motion compensation difference signal from a motion generated by a motion compensator 135 or a null signal, according to the position of a switch 140.

The code mode for each macroblock (MB) input to the transcoder of FIG. 1 (either intra or inter mode) is embedded in the input pre-compressed bit stream and provided to the switch 140. The output of the adder 30 is provided to the encoder 150 and to a current frame buffer (C_FB) 145 of the decoder 110. The motion compensator 135 then uses data from the current FB 145 and from the previous frame buffer (P_FB) 150, along with motion vector data (MV) from the VLD 115. In the encoder 150, pixel data is provided to an intra/inter mode switch 155, an adder 160, and a motion estimation (ME) function 165. The switch 155 selects either the current pixel data, or the difference between the current pixel data and pixel data from a previous frame, for processing by a DCT processor 170, quantizer 175, and variable length coder 180. The output of the variable length coder 180 is a bitstream that is transmitted to a decoder, and that includes motion vector data from the motion estimator 165. Finally, a rate adjust circuit Q2 controls the bit output rate of the transcoder.

In a feedback path, processing at the inverse quantizer 182 and inverse DCT processor 184 is performed to recover the pixel domain data. This data is then summed with the motion compensation data or null signal at the adder 186, and the sum is provided to a current frame buffer 190. Data from the current frame buffer 190 and a previous frame buffer 192 are provided to the motion estimator 165 and motion compensator 194. A switch 196 directs either a null signal or the output of the motion compensator 194 to the adder 186 in response to the intra/inter mode switch control signal.

As is apparent from the above, this approach requires extensive computational resources to fully decompress and re-compress the incoming video stream. Because the transcoder requires the whole functionalities of both MPEG encoding and decoding, the cost is relatively high and the transcoder is in general only practical with respect to the head end or source of the video stream, and not at nodes where bandwidth adjustment is most needed.

An alternative approach improves the computational efficiency of the conventional transcoder shown in FIG. 1 by recycling the motion compensation already done in the incoming compressed video stream. An example of an MPEG video transcoder which eliminates the motion compensation step is illustrated in FIG. 2. This method and apparatus are based on the discovery that if the picture type for each frame is maintained during transcoding, the motion vectors decoded from the decoder can be used for motion compensation purposes in the encoder without significantly impairing the perceptual quality of the resulting image, thereby eliminating the need for the computationally intensive motion compensation operation.

The transcoder of FIG. 2, with the exception of the motion vector processing, is identical to that of FIG. 1, and therefore identical elements in FIG. 2 have been correspondingly numbered. Like the transcoder of FIG. 1, the transcoder 200 of FIG. 2 includes an MPEG video extractor 105, MPEG decoder 210, and an MPEG encoder 250. On the other hand, in contrast to the transcoder of FIG. 1, transcoder 200 provides the motion vectors from VLD 115 directly to motion compensator 194 in the encoder 250. As a result, the transcoder architecture of FIG. 2 will generate a new bitstream with a new bit rate, without having to perform new motion compensation operations. Despite this improvement in efficiency, however, computational effort is still relatively high due to the DCT and IDCT operations involved in encoding and decoding, respectively.

If a video transcoding method or apparatus is to be practical, it should be as simple as possible since the service must be provided not only at the headend of transmission but also at routers. It should avoid all MPEG components with high computational demand, such as motion estimation, DCT, IDCT, and so forth, and should be able to adjust the bit rate of transmitting the video stream according to the available network bandwidth without significantly degrading video quality. No such method or apparatus is currently available.

### SUMMARY OF THE INVENTION

It is accordingly a first objective of the invention to provide a video transcoding method and apparatus capable of facilitating digital video transmission over various network infrastructures having different bandwidths without significantly perceptible degradation in video quality.

It is a second objective of the invention to provide a video transcoding method and apparatus that can be applied to any node on a network, including the Internet and wireless communications networks, and that is capable of efficiently and dynamically transcoding video data to fit the available bandwidth.

It is a third objective of the invention to provide a video transcoding method and apparatus that does not require the performance of computationally intensive motion compensation, discrete cosine transforms, or inverse discrete cosine transforms.

These objectives are accomplished, in accordance with the principles of a preferred embodiment of the invention, by providing a video transcoding engine that, in its broadest form, decomposes a video stream to block level and remembered information necessary to repack the post-processed video signals; processes the incoming video signals to adapt bit rate by setting an error range for each DCT frequency in the decomposed video signals; and repacks the transcoded video signals in the same format as the incoming video signals.

More specifically, when applied to an MPEG coded video stream, the transcoder of the preferred embodiment extracts MPEG data from the incoming video stream wrapper, decomposes the MPEG data to the block layer, and rearranges the VLC coding of the DCT coefficients in the video stream wrapper at the block level by assigning an allowable error range to each DCT frequency based on the available network bandwidth and/or the effect of the DCT code on perception of picture quality and searching for the code word having the smallest length in the allowable error range to fit the available bandwidth. Thus, instead of fully decoding the video stream by performing a pair of inverse DCT and DCT operations on the data, only the DCT coefficients of each MPEG block are processed in the DCT frequency domain to adjust video traffic.

The significantly greater efficiency of the preferred transcoder is achieved because it utilizes motion-compensation, quantization, zig-zag scanning in the order of frequency, and variable length coding of the DCT coefficients in each MPEG block that have already been carried out by a previous MPEG encoder, and simply adjusts the DCT coefficients without performing a new transform or inverse transform. By first assigning small length codes to likely patterns and large length codes to unlikely patterns according to the MPEG standard, and then converting the unlikely patterns to likely patterns as necessary to fit the video signal into the available network bandwidth, as determined by a conventional rate control engine, the degradation of video quality caused by the transcoding engine is much less perceptible than can be achieved by randomly dropping video information.

Although the invention is described herein by reference to the specific example of MPEG coded video, those skilled in the art will appreciate that the invention may also be adapted to other block level video compression formats with variable length codes.

### BRIEF DESCRIPTION OF THE DRAWINGS

FIG. 1 is a schematic diagram of a conventional video transcoder with complete decoding/encoding.

FIG. 2 is a schematic diagram of a prior art video transcoder with efficiency improvement by removing motion estimation from the transcoding architecture.

FIG. 3 is a schematic diagram of a bandwidth scalable video transcoder architecture constructed in accordance with the principles of a preferred embodiment of the invention.

FIG. 4 is a flowchart of a method of implementing the transcoder architecture illustrated in FIG. 3.

FIG. 5 illustrates a sample of a coded block before bandwidth scalable video transcoding according to the principles of the method and apparatus illustrated in FIGS. 3 and 4.

FIG. 6 is a table giving the error range for each of a plurality of corresponding DCT components.

FIG. 7 is a table illustrating a coded block after bandwidth scalable video transcoding according to the principles of the preferred embodiment of the invention.

### DETAILED DESCRIPTION OF THE PREFERRED EMBODIMENTS

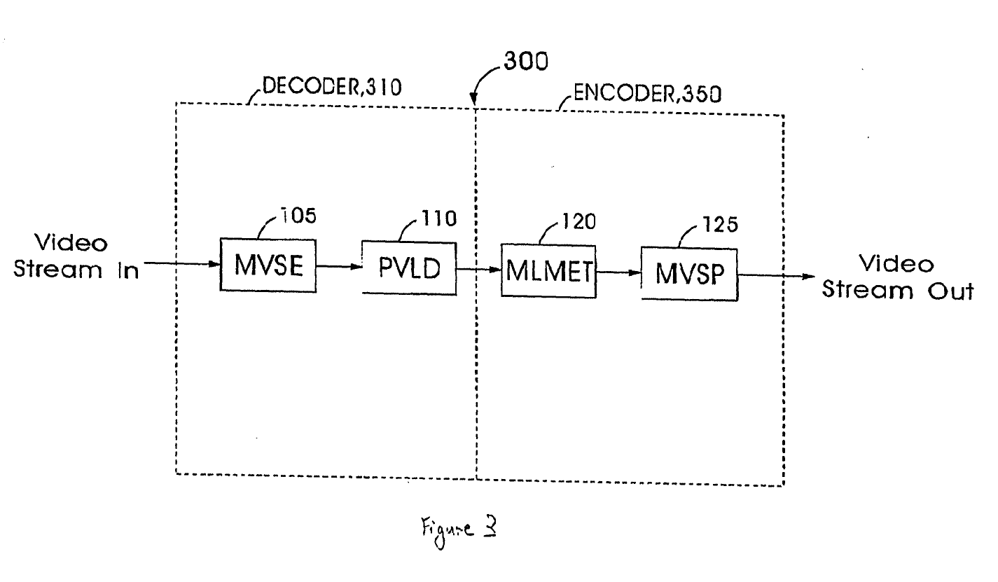

As illustrated in FIG. 3, the invention is implemented by a transcoding engine that can be applied to any router and that includes a transcoder 300 made up of a decoding device 310 and an encoding device 350. However, unlike conventional transcoders, the decoding and encoding devices of the preferred embodiment do not perform full encoding and decoding. Instead, they make use of the layered structure of the MPEG video coding standard.

To understand the transcoding method of the invention, an understanding of some basic principles of video compression and MPEG coding, which operates on multiple levels of the video stream, is necessary. According to the MPEG standard, at the bottom layer of the coded video stream are blocks composed of 8×8 pixels. The 8×8 blocks in the pixel domain are converted to the frequency domain by a discrete cosine transformation, which efficiently removes spatial correlation between nearby pixels within the same image (intraframe coding) when the correlation is low. In addition, to account for high correlation between pixels in nearby frames, MPEG adds interframe coding techniques with motion compensation. As a result, while the correlation between prediction residuals is removed by the discrete cosine transform, the DCT coefficients are in addition zig zag scanned in the order of frequency, quantized, and VLC coded. The MPEG video compression is achieved in the steps of quantization and VLC coding. The purpose of zig-zag scanning is to trace the low frequency DCT coefficients, which contain the most energy, before tracing the high frequency coefficients. This zig-zag scanning is used to achieve VLC coding.

Variable length coding begins with detection of the non-zero quantized coefficients along the scan line, and detection of the distance (run) between two consecutive non-zero coefficients, each consecutive “run, length” pair is encoded by a unique VLC code word. The more likely a pattern occurs in each pair, the shorter the VLC code word assigned to it. Since the number of patterns in (run, length) pair is a huge number, not every pattern maps to a VLC code word. As a result, fixed length coding techniques are applied to most of the patterns. The fixed length code words are much longer than the VLC code words.

The invention solves this problem by transferring unlikely patterns to likely patterns in a way that takes into account the discovery that the significance of DCT coefficients to the human visual system runs from low frequency to high frequency, which suggests that the human visual system is less sensitive to the coding errors of high frequency DCT than low frequency DCT, and therefore that while unlikely patterns cannot be ignored, one can minimize the perceptual impact of the transfer by excluding transfers of low frequency DCT codes.

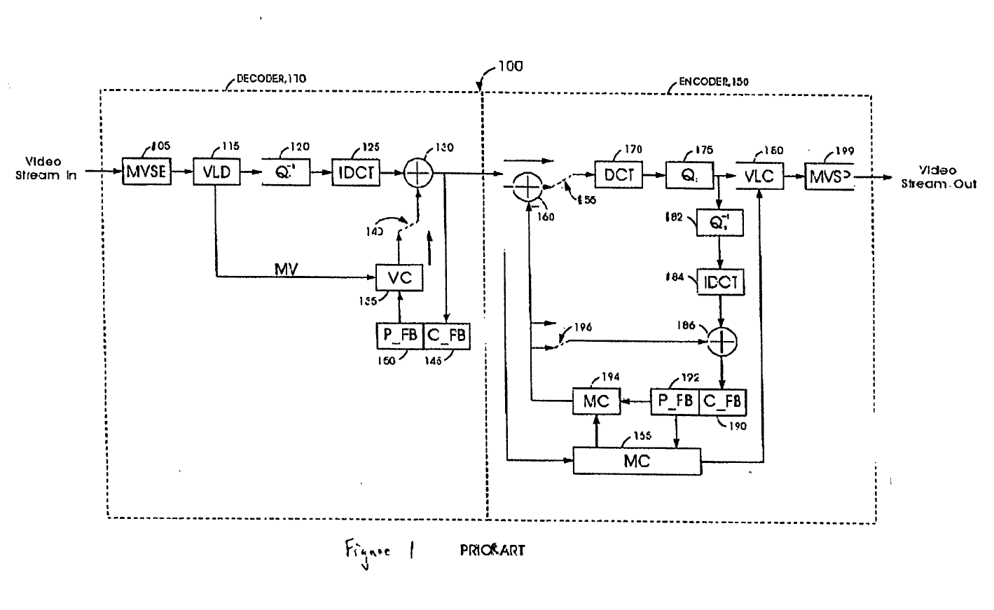

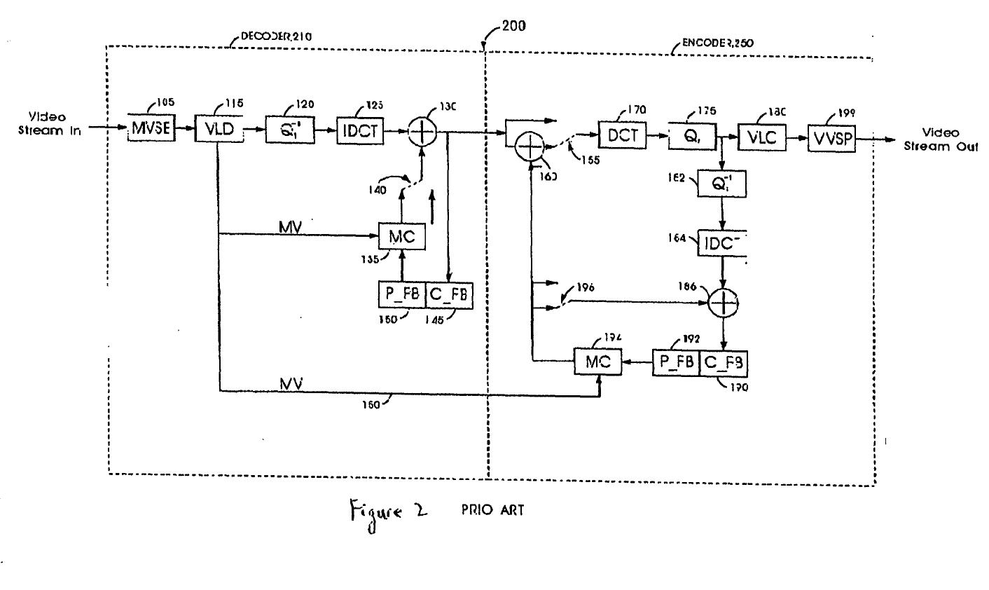

In the preferred embodiment, perceptual impact is minimized by assigning an allowable error range to each DCT frequency. Once the allowable error range has been assigned, transfers can be systematically made with minimal effect on the perception of errors. Thus, the decoder 310 of transcoder 300 only requires an MPEG video stream extractor (MVSE) 105 corresponding to MVSE 105 shown in FIGS. 1 and 2, and a variable length decoder (PVLD) 115 corresponding to the conventional VLD shown in FIGS. 1 and 2, except that decoding is “partial” as will be explained below.

The one element of the architecture shown in FIG. 3 that has no correspondence in the transcoders of FIGS. 1 and 2 (other than the elimination of numerous elements such as the DCT processors), is the inclusion in encoder 350 of a maximum error translator 320 that, within the allowable error range, looks for the code word with minimum length possible for the corresponding run, length pair and makes the substitution. The modified coding is then applied by MPEG video stream processor 125 to re-pack the extracted and processed coefficients. If a DCT coefficient has a value of zero, its corresponding allowable error will be forced to zero, which means that the DCT coefficient with zero value cannot be changed.

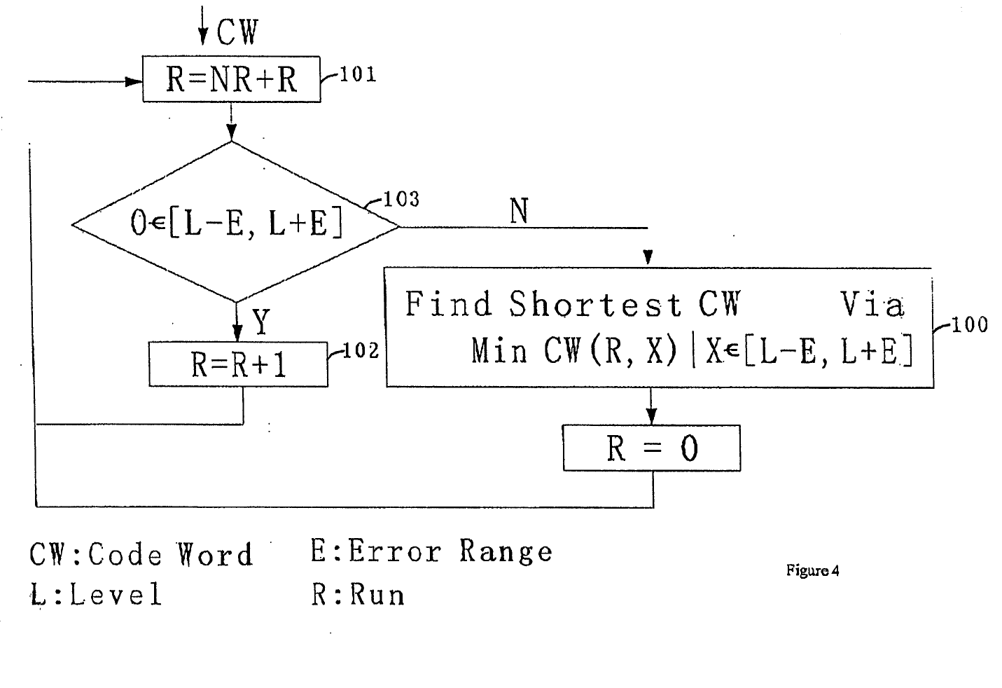

The working flow of the method is illustrated in FIG. 4. In FIG. 4, CW denotes code word, NR stands for new run, E for error range, and R and L represent run and length, respectively, and step 100 is the processing step that determines the minimum length code word for a particular run, length pair within the allowable error range. Steps 101 and 102 set flags for a particular run, and step 103 determines if the error range includes zero, in which the step of finding the minimum code word can be skipped. Since MPEG does not allow all the DCT coefficients to be zero for some type of block, and the transcoder of the invention preferably should enforce the rule, for the blocks that do not allow all DCT coefficients to be zero, the preferred transcoder enforces the first non-zero DCT coefficient to not be zero.

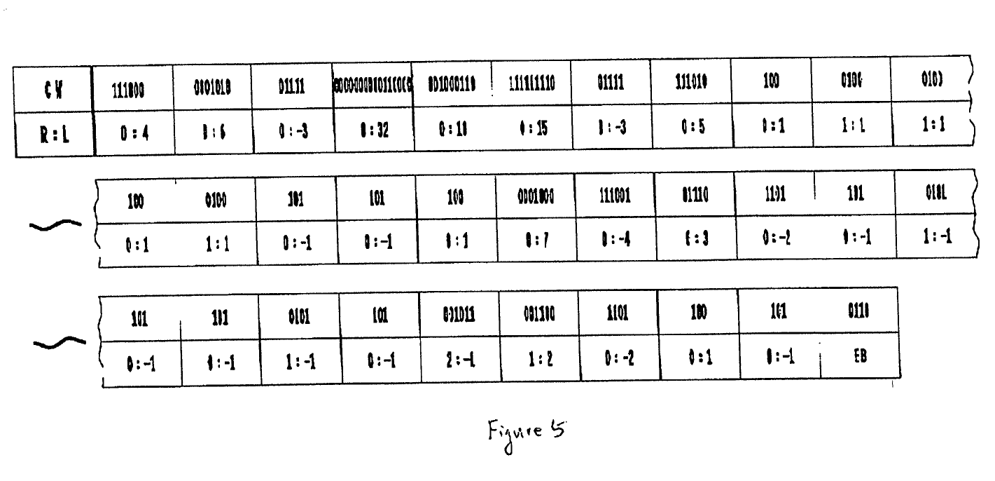

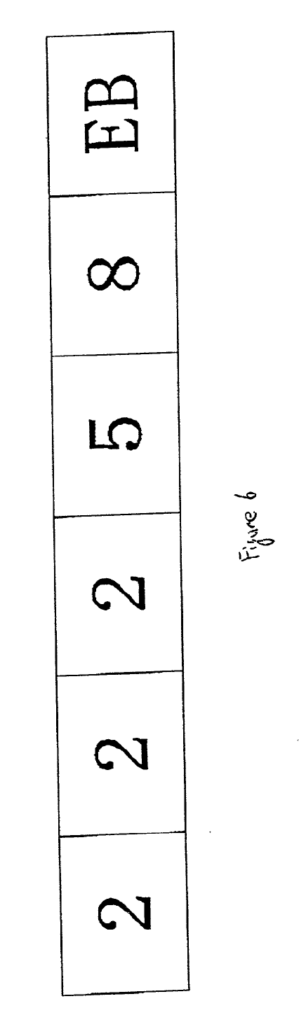

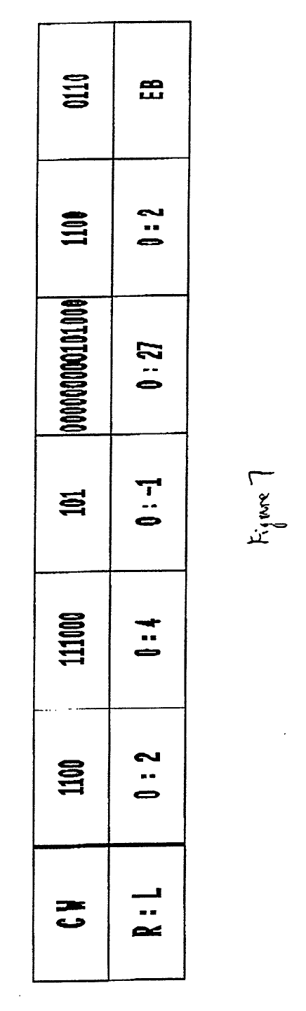

FIG. 5 shows an example of a coded block and FIG. 6 gives the error range for each DCT frequency in the coded block. Since DCT coefficients have different effects on video quality, the corresponding error range for each DCT frequency should reflect the difference. Denoting Dᵢ as the i^{th} DCT coefficient in the zigzag scanned DCT array and denoting Eᵢ as the error range of Dᵢ, since Dᵢ is more significant to the human visual system than Dⱼ for i<j, Eᵢ and Eᵢ should satisfy the relationship Eᵢ≦Eⱼ. If Dₘₐₓ represents the highest value possible that a DCT coefficient can take and Eᵢ≧Dₘₐₓ, then Dⱼ′=0, j≧i where Dⱼ′ denotes the transcoded value of Dⱼ. According to this argument, the end of the block must occur before the Dᵢ where Eᵢ≧Dₘₐₓ. Values that exceed Dₘₐₓ are designated in FIG. 7 by the letters EB.

According to the above transcoding scheme, the resulting transcoded block can be discerned in FIG. 7. The first run, length pair is (0,4) and the error range of the first DCT component is 2. Based on the method set forth in FIG. 4, the run, length pair of (0,4) is transcoded to (0,2) and the code word is changed from 111000 to 1100. From the same process, (0,6) with code word of 00001010 is transcoded to (0,4) with code word of 111000, (0,-3) with code word of 01111 is transcoded to (0,-1) with code word of 101, (0,32) with code word of 00000000000110000 is transcoded to (0,27) with code word 000000000101000, and (0,10) with code word of 001000110 is transcoded to (0,2) with code word of 1100, followed by the end of the block.

In this example, the total number of bits used to code the block is 158 before transcoding and 36 after transcoding. As a result, 122 bits are saved by the preferred transcoding scheme. The coding efficiency improves by more than 77% in this particular example.

As illustrated in FIG. 3, the VLD is actually a partial variable length decoder (PVLD). This is because if Eᵢ=EB, then the end of the block must occur before the i^{th} component. Therefore, it is not necessary to VLD decode the code words after the i^{th} component.

Those skilled in the art will appreciate that the bandwidth scalable video transcoder of the invention serves the sole purpose of facilitating video transmission over various network infrastructures, by employing a minimum length maximum error translator mechanism to provide a trade-off between video traffic and video quality. To accomplish this, the transcoder of the invention: (1) determines the allowable error ranges for DCT frequencies based on the available network bandwidth and/or the effect of the DCT code on perception of picture quality, and (2) looks for the code word with minimum length possible for a corresponding run, length pair and uses that code word as the new VLC within the allowable error range. The larger the allowable error ranges that are assigned to the DCT frequencies, the more traffic is trimmed off from the incoming video stream. Therefore, the traffic can be tuning of the allowable error ranges. The resulting degradation of video quality is much less noticeable than for random traffic dropping.

Since the transcoding functionality of the preferred embodiment does not require special hardware devices and can be implemented solely by means of software, although special hardware devices are not excluded from the scope of the invention, the transcoder can easily be implemented in network routers and bridges, content servers, and so forth. In addition, the invention may be applied to any block-based video codec in addition to the MPEG series, such as the H.26x series.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

I claim:

1. A method of transcoding compressed digital video data, comprising the steps of:
a. decomposing a video stream to block level and remembering information necessary to repack the post-processed video signals;
b. post-processing the incoming video signals to adapt bit rate by setting an error range for each discrete cosine transform (DCT) frequency in the decomposed video signals;
c. repacking the transcoded video signals in the same format as the incoming video signals.

2. A method as claimed in claim 1, wherein said video data is extracted from an MPEG coded video stream.

3. A method as claimed in claim 2, wherein step b comprises the steps of adapting video traffic through rearranging variable length coding (VLC) of the DCT coefficients in the video stream wrapper at the block level by assigning an allowable error range to each DCT frequency based on at least one of the available network bandwidth and the effect of the DCT code on perception of picture quality, and changing large length codes to small length codes as necessary to fit the available bandwidth.

4. A method as claimed in claim 2, wherein the remembered information includes, for each MPEG block, information concerning motion-compensation, quantization, and zig-zag scanning in the order of frequency as carried out by a previous MPEG encoder.

5. A method as claimed in claim 2, wherein step b is carried out by a maximum error translator that determines an allowable error range for each DCT frequency based on at least one of the allowable network bandwidth and the effect of the DCT code on the perception of picture quality, and that, within the allowable error range, looks for the code word with minimum length possible for a corresponding run, length pair and uses that code word as the VLC.

6. A method as claimed in claim 1, wherein said repacking step comprises the step of combining the remembered video information with the transcoded video signals to provide new video traffic having a desired bit rate.

7. A method as claimed in claim 1, wherein steps a-c are carried out by software at a node or router on a network.

8. A method as claimed in claim 7, wherein said network is selected from the group consisting of the Internet, a local area network, and a wireless network.

9. Software for transcoding compressed digital video data, comprising:
a. means for decomposing a video stream to block level and remembering information necessary to repack the post-processed video signals;
b. means for post-processing the incoming video signals to adapt bit rate by setting an error range for each discrete cosine transform (DCT) frequency in the decomposed video signals;
c. means for repacking the transcoded video signals in the same format as the incoming video signals.

10. Software as claimed in claim 9, wherein said video data is extracted from an MPEG coded video stream.

11. Software as claimed in claim 10, wherein said post-processing means comprises means for adapting video traffic through rearranging variable length coding (VLC) of the DCT coefficients in the video stream wrapper at the block level by assigning an allowable error range to each DCT frequency based on at least one of the available network bandwidth and the effect of the DCT code on perception of picture quality, and means for changing large length codes to small length codes as necessary to fit the available bandwidth.

12. Software as claimed in claim 10, wherein the remembered information includes, for each MPEG block, information concerning motion-compensation, quantization, and zig-zag scanning in the order of frequency as carried out by a previous MPEG encoder.

13. Software as claimed in claim 10, wherein said post-processing means includes a maximum error translator that, within the allowable error range, looks for the code word with minimum length possible for the corresponding run, length pair and uses that code word as the VLC.

14. Software as claimed in claim 9, wherein said repacking means includes means for combining the remembered video information with the transcoded video signals to provide new video traffic having a desired bit rate.

15. Software as claimed in claim 9, wherein said software is located at a node or router on a network.

16. Apparatus for transcoding compressed digital video data, comprising:
a. a video stream extractor arranged to decompose a video stream to block level and remember information necessary to repack the post-processed video signals;
b. a maximum error translator that, within the allowable error range, looks for the code word with minimum length possible for a corresponding run, length pair in the decomposed video stream and uses that code word as the variable length coding (VLC);
c. a coder arranged to repack the transcoded video signals in the same format as the incoming video signals.

17. Apparatus as claimed in claim 16, wherein said video data is extracted from an MPEG coded video stream.

18. Apparatus as claimed in claim 17, wherein said maximum error translator is arranged to assign an allowable error range to each DCT frequency based on at least one of the available network bandwidth and the effect of the DCT code on perception of picture quality, and to change large length codes to small length codes as necessary to fit the available bandwidth.

19. Apparatus as claimed in claim 17, wherein the remembered information includes motion-compensation, quantization, zig-zag scanning in the order of frequency, and variable length coding of the DCT coefficients in each MPEG block that have already been carried out by a previous MPEG decoder.

20. Apparatus as claimed in claim 16, wherein said coder combines the remembered video information with the transcoded video signals to provide new video traffic having a desired bit rate.

21. Apparatus as claimed in claim 1, wherein said apparatus is adapted to transcode video data at a node or router on a network.
